(19) United States
(12) Patent Application Publication
(10) Pub. No.: US 2014/0183426 A1
(43) Pub. Date: Jul. 3, 2014

(54) Wire Handheld Tool

(71) Applicant: ROBERT BOSCH GMBH, Stuttgart (DE)

(72) Inventors: Larry Betcher, Northfield, MN (US); Dirk Skogerboe, Faribault, MN (US)

(73) Assignee: ROBERT BOSCH GMBH, Stuttgart (DE)

(21) Appl. No.: 13/731,295

(22) Filed: Dec. 31, 2012

(51) Int. Cl. H02G 1/00

(52) U.S. Cl. CPC H02G 1/00
USPC 254/134.3 R

(57) ABSTRACT

A wire handheld tool including a handle contiguous to a shank with a wire engaging end. The wire engaging end may be a helically shaped portion used to engage one or more wires thereto. The wire handheld tool can be used to insert, remove, and/or replace wires contained in wire loom split tubing. Some embodiments can include one or more spiral scrolls in the helically shaped portion. In addition, the end of the helically shaped portion may include wire anchoring structures useful to attach or detach one or more wires by rotating motion of the wire handheld tool. The handle of the tool can be ergonomically designed for comfort and practicality, and additionally, may include non-conductive components or coatings to prevent electrically shocking a user.

### FIELD OF THE DISCLOSURE

The disclosure generally relates to a device used for inserting, replacing and/or guiding wiring along a containing duct. More particularly, a wire handheld tool used for inserting, replacing and/or guiding wiring along wire loom split tubing.

### BACKGROUND OF THE DISCLOSURE

A number of fields currently benefit from an array of wire handling and wire containing techniques. Different techniques employ different tools and parts that can be used in order to contain wires in an organized manner. Containing and managing wires is important for a number of reasons depending on the application including, for example, keeping the wires contained to minimize tripping hazards, routing wires in spaces that can sometimes become difficult to access, preventing wire entanglement with equipment, protecting wiring, and the like.

Some techniques commonly used include the use of wire containing ducts to organize and contain wires. For example, in many industries, such as the automotive industry, the use of wire loom split tubing is widely known. Different tools specific to the construction and assembly of new wiring harnesses have been developed as a consequence. Nevertheless, these tools are less than satisfactory. Typically, during installation, repairs, and replacement of wires, mechanics and electricians often find themselves using their finger to push the wire into the loom due to the lack of practicality of the currently available tools. Using fingers during repairs can cause skin damage, can be time consuming, and the like. Other approaches have utilized a tool with a clip to attach a wire end and insert the wire end into an end of the split duct to then drag it along. Such approaches are cumbersome and time consuming.

As a result of the foregoing, there is a need for a tool that can facilitate the installation and/or replacement of wires into conduits such as a wire loom split tubing.

### SUMMARY OF THE DISCLOSURE

Accordingly, the foregoing needs are met, to a great extent, by the present disclosure, wherein a wire handheld tool useful to insert, assemble and/or replace wires into conduits such as a wire loom split tubing is described. In some aspects of the disclosure, a wire handheld tool for at least one of inserting, removing and replacing a wire into a wire containing split duct includes a handle configured to be held by a user with a longitudinal shank with a first end connected to the handle and the longitudinal shank including a second end comprising a wire engaging portion. The wire engaging portion which can be configured to guide one or more wires into or out of the wire containing split tubing.

The handle may be of any geometric form and size for a user to easily grip the tool and manipulate the shank portion. In some embodiments, the handle and/or shank may be made of or coated with a non-conductive composition to protect the user from being electrically shocked during repair due to damaged wires. The wire engaging end of the shank may include a helically shaped portion that can be useful for at least one of inserting, removing and replacing a wire into a wire containing split tubing.

In some embodiments according to aspects of the disclosure, the helically shaped portion of the shank's wire engaging end relates to a curved spiral like structure. The curved spiral structure may be a rigid structure and can include one or more spiral scrolls capable of engaging one or more wires by twist motion of the wire handheld tool, or twisting the wire. The number of spiral scrolls and diameter thereof may depend on the number of wires, size of wires, and the application. In some embodiments used for motor vehicle assembly and/or repair, the curved spiral structure may contain from one spiral scroll to three spiral scrolls or more. In addition, the curved spiral structure can be a twist that is less than an entire spiral scroll and it may include an attachment feature proximate to an end of a wire engaging end of the shank. The attachment feature may also be included in embodiments where the curved spiral portion includes one or more entire spiral scrolls.

In some aspects of the disclosure, the wire handheld tool can be used during wire assembly and/or repair as a means to insert and/or guide one or more wires into the wire loom split tubing. A wire may be inserted and guided, for example, by engaging a portion of the wire into/onto a helically shaped portion of the shank's wire engaging end, inserting the wire engaging end with the engaged wire into wire loom tubing, and guiding the wire handheld tool along the length of the wire loom tubing using the handle of the wire handheld tool. In some embodiments, the wire may be engaged through means that do not require inserting the wire into the helically shaped portion including but not limited to coupling an anchoring structure of the wire engaging end with the wire and/or a wire component.

In additional aspects of the disclosure, the wire device can be used during wire repair or replacement by inserting the helically shaped portion of the shank's wire engaging end into a wire loom tube, engaging one or more wires, and guiding at least a section of the one or more wires out of the wire loom tubing.

Moreover, when more than one wire is included in the wire loom tubing, the wire may be removed without significantly disrupting other wires, causing entanglement, and/or requiring the wire loom split tube to be opened to a degree that may cause damage to the wire loom split tube. Similarly, the device may be used to replace wires by inserting one or more wires in the wire containing loom split tube. In some aspects of the disclosure, the easy anchoring and detaching by twist motion can facilitate and speed up the process in ways that do not require the user to insert his/her fingers into the wire loom split tube.

Related to the disclosure, a wire may include but is not limited to cables, lines, leads, fiber optic cables, and strings being inserted into a flexible, semi-rigid or rigid split tube enclosing structure. The size of the device can be proportional to the application and the size of the shank and the helically shaped end can be so that it fits in the longitudinal groove along the tube by twist motion in flexible or semi-rigid tube like structures, by manipulating the longitudinal groove with the application of sufficient force to increase the size of the groove enough to fit the helically shaped portion but without damaging the tube structure.

There has thus been outlined, rather broadly, certain aspects of the disclosure in order that the detailed description herein may be better understood, and in order that the present contribution to the art may be better appreciated.

In this respect, before explaining at least one embodiment of the disclosure in detail, it is to be understood that the disclosure is not limited in its application to the details of the construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 is a side view and a top view of an exemplary wire handheld tool in accordance with some embodiments of the disclosure.

FIG. 2 illustrates the exemplary wire handheld tool of FIG. 1 being used to engage a wire onto a helically shaped portion of the shank's wire engaging end in accordance with some aspects of the disclosure.

FIG. 3 illustrates the exemplary wire handheld tool of FIG. 1 being used to replace a wire from wire loom split tubing in accordance with some aspects of the disclosure.

FIG. 4 illustrates another exemplary wire handheld tool in accordance with some embodiments of the disclosure.

FIG. 5 illustrates exemplary helically shaped ends of the shank's wire engaging end that may be useful in some embodiments of the disclosure.

FIG. 6 illustrates the exemplary wire handheld tool of FIG. 1 being used to insert and guide a wire into wire loom split tubing in accordance with some aspects of the disclosure.

### DETAILED DESCRIPTION OF THE DISCLOSURE

The disclosure will now be described with reference to the drawing figures. Throughout the description of the drawings, figures in which like reference numerals are used can refer to like parts throughout. However, any feature described in relation to any one aspect may be used alone, or in combination with other features described, and may also be used in combination with one or more aspects described or variations that will be readily apparent to those skilled in the art.

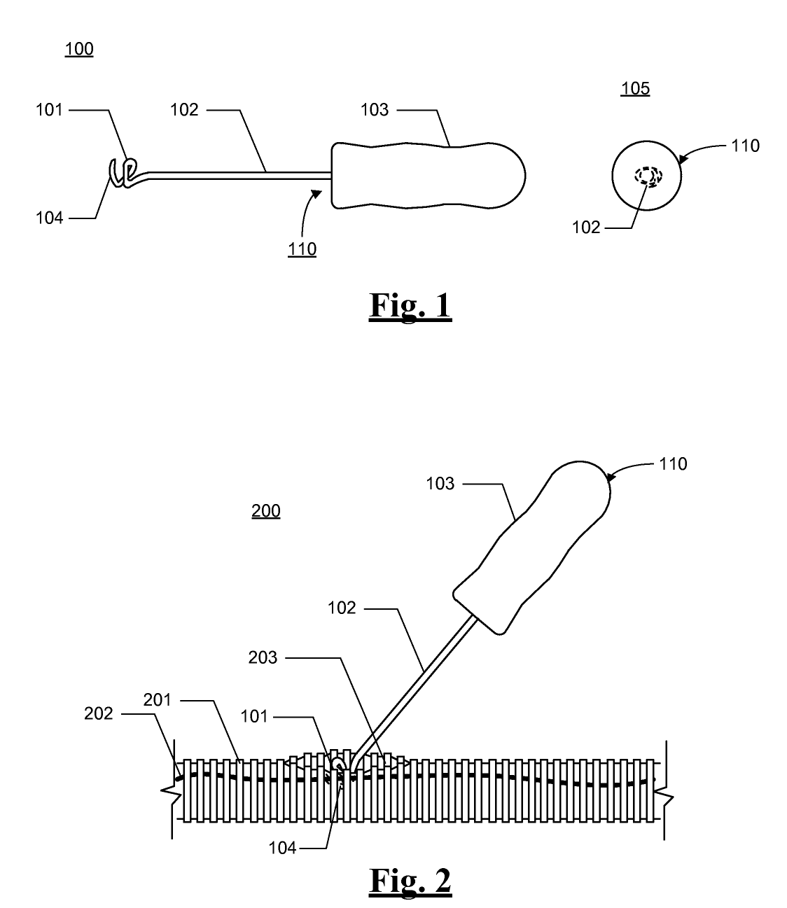

Referring now to FIG. 1, a side view 100 and a top view 105 of an exemplary wire handheld tool 110 in accordance with some embodiments of the disclosure are depicted. According to aspects of some embodiments of the disclosure, the wire handheld tool 110 includes a handle 103 contiguous to a longitudinal shaft or shank 102 with a wire engaging end 101. The handle 103 may be of any geometric shape that allows a user to hold the wire handheld tool 110. In some embodiments, the handle 103 may be of an ergonomic geometric shape that provides for a comfortable grip to the user. For example, a generally cylindrical shaped handle 103 that can conform to the closed hand of a user. Some wire handheld tools 110, within the scope of the disclosure, used for the assembly and repair of small devices may include a differently shaped or sized handle 103 that provides for a user control by simply grabbing the handle 103 with three or fewer fingers.

In some embodiments, the handle 103 may be a rigid structure of a non-conductive composition or a metal composition with a non-conductive coating to prevent electrical shock of the user when the wire handheld tool 110 comes into contact with a wire 202 (FIG. 2). Rigid and non-conductive materials can include polymers, ceramic compositions, or the like. Suitable polymers include but are not limited to rigid plastics, rubbers, acrylics, nylons, polystyrenes, polyvinylchlorides, polycarbonates, polyurethanes, polyethylenes, polypropylenes, polyamides, polyethers, polyesters, polyolefins, polyacrylates, polyisoprenes, fluoropolymers, combinations thereof or the like. In some additional embodiments, the handle 103 may also include a sponge like heat and/or electrically insulating foam material covering a rigid portion of the handle 103 that can provide additional comfort and safety.

The shank 102 may be an elongated longitudinal and relatively rigid component with a first end being contiguous to the handle 103 and further having a second wire engaging end 101. The shank's 102 elongated longitudinal structure can be functional to fit in a groove opening 203 (FIG. 2) of wire loom split tubing 201 and engaging to remove a wire 202, or inserting an engaged wire 202, and/or guiding and disengaging the wire 202 by control of the handle 103.

In some embodiments of the disclosure, the shank's 102 elongated longitudinal shape may include one or more bends that may be useful, for example, to guide the wire 202 along the wire loom split tubing 201. The shank 102 is configured to engage a portion of the wire loom split tubing 201 and further open the tubing as the wire handheld tool 110 is guided along the tubing. In addition, the composition of the shank 102 may also be of a non-electrically conductive material and/or may allow for some bending through the application of force in order to accommodate the wire handheld tool 110 in tight working spaces or to customize the tool as desired by the user.

The wire engaging end 101 may include a helically shaped structure portion 104. The helically shaped structure portion 104 can be relatively rigid and generally have a curved spiral geometry. The curved spiral geometry can include one or more spiral scrolls capable of engaging and/or disengaging one or more wires 202 by twist motion of the wire handheld tool 110. However, in some embodiments the curved spiral geometry can be a twist that is less than an entire spiral scroll and includes an attachment feature proximate to the end of the helically shaped structure portion 104 of the shank 102. The inclusion of the attachment feature and/or the number of spiral scrolls and diameter thereof can depend on the application. For example, the construction may depend on the number of wires 202 and size of wires 202 involved. In some embodiments used in the automotive industry, the curved spiral structure may contain from one spiral scroll to three spiral scrolls or more. Other wire engaging end 101 constructions are contemplated as well.

Referring now to FIG. 2, the exemplary wire handheld tool 110 of FIG. 1 being used to engage the wire 202 onto a helically shaped structure portion 104 of the shank's 102 wire engaging end 101 in accordance with some aspects of the disclosure is depicted. Conventional wire loom split tubing 201 is depicted containing the wire 202 within the space inside the wire loom split tubing 201 (shown opaque). A split opening within the longitudinal groove opening 203 included in wire loom split tubing 201 can be used to insert a portion of the shank 102 including the wire engaging end 101 and engage the wire 202 onto/into the wire engaging end 101. For example, in some embodiments the wire engaging end 101 includes at least a portion of the helically shaped structure portion 104 which may be inserted into the wire loom split tubing 201 and used to engage or disengage the wire 202.

Engaging and disengaging one or more wires 202 are often desired during the repair and service of wires 202 already contained in the wire loom split tubing 201. As a result, after inserting portion of the shank 102 of the wire engaging end 101 including at least a portion of the helically shaped structure portion 104, a user may manipulate the wire handheld tool 110 to engage or disengage the wire 202 onto/into the helically shaped structure portion 104. Due to the helically shaped structure portion 104 of the wire engaging end 101, manipulation preferably includes a twist motion of the wire handheld tool 110 in either clockwise or counterclockwise direction to engage/disengage the wire 202 according to the direction of the spiral design.

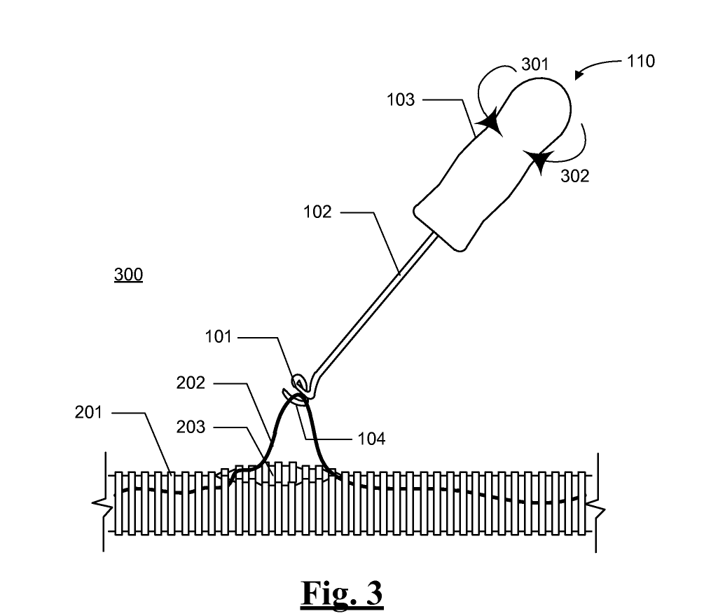

Referring now to FIG. 3, the exemplary wire handheld tool 110 of FIG. 1 being used to replace a wire 202 from wire loom split tubing 201 in accordance with some aspects of the disclosure is depicted. As previously described, due to the helically shaped structure portion 104 of the wire engaging end 101, manipulation by twist motion of the wire handheld tool 110 in either clockwise 301 or counterclockwise 302 directions can either engage the wire 202 onto/into the helically shaped structure of the shank 102 according to the direction of the spiral design by rotating the body of the wire handheld tool 110 or in the counterclockwise direction 301, the wire 202 may detach from the wire handheld tool 110. Detaching the wire 202 may be desired while inside or outside of the wire loom split tubing 201 and rotating motion functionality may be useful, for example, when repaired wire 202 is being inserted into the wire loom split tubing 201.

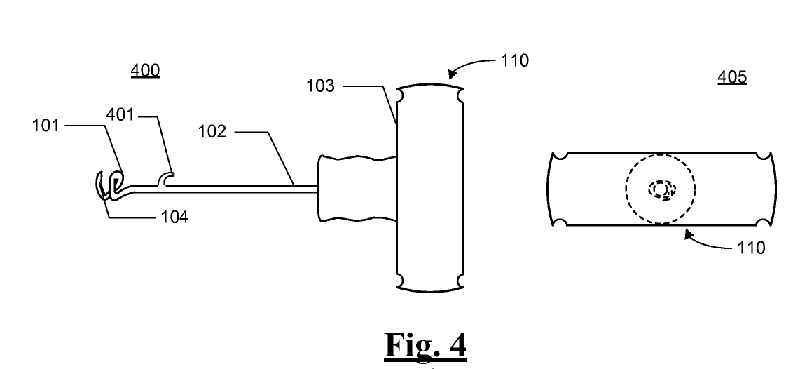

Referring now to FIG. 4, a side view 400 and top view 405 of another exemplary wire handheld tool 110 is depicted. In the present exemplary embodiment, the handle 103 is designed to be T-shaped to allow a user to ergonomically grab the wire handheld tool 110, rotate the shank 102, and comfortably pull a wire 202 into or out of the wire loom split tubing 201 by sliding the wire handheld tool 110 in relation to the longitudinal groove 203 of the wire loom split tubing 201. In some embodiments of the disclosure, the shank 102 includes an additional wire holding feature 401 that can allow a user to manipulate more than one wire 202 during sliding motion. For example, while inserting one wire 202 into the wire loom split tubing 201, a second wire (not shown) may be pulled out of the wire loom split tubing 201 by engagement of the second wire with the wire holding feature 401. Also, the wire holding feature 401 may be used to hold a wire cap, wire couplers, or any part used in the art.

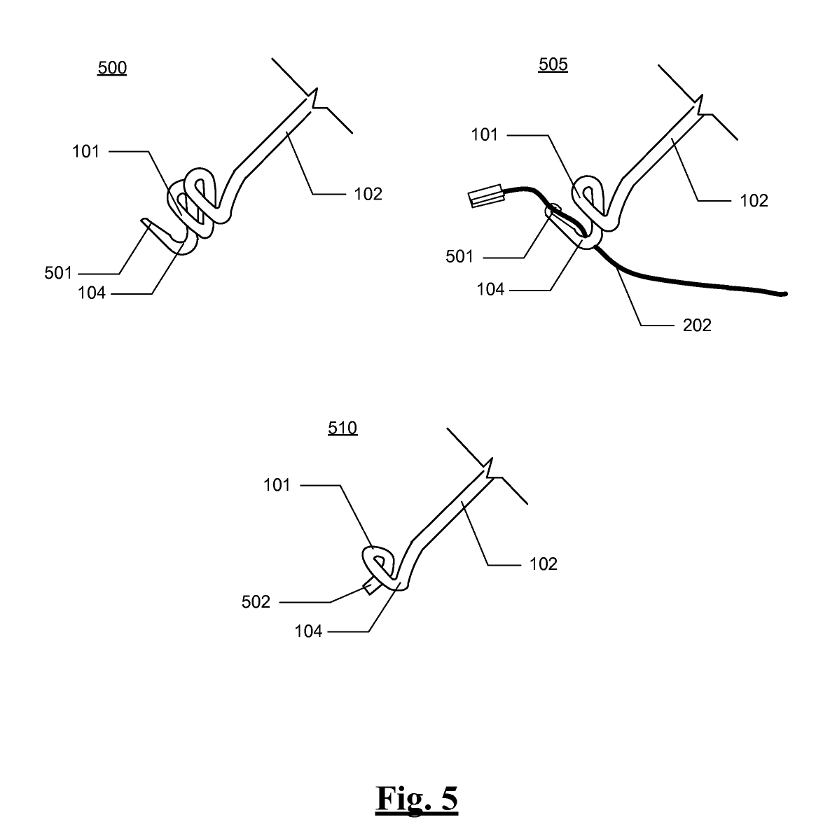

Referring now to FIG. 5, exemplary helically shaped structure portions 104 of the shank's 102 wire engaging end 101 that may be useful in some embodiments of the disclosure are depicted. In one embodiment 500, the helically shaped structure portion 104 of the wire engaging end 101 includes two entire spiral scrolls and/or a flat anchoring structure 501. This type of helically shaped structure 104 may be advantageous in applications that require more careful handling of the wires 202 due, for example, to how relatively thin they are or to their condition. Entire spiral scrolls may be used to separate wires 202 in each scroll during the insertion and/or replacing of the wires 202.

In other embodiments, as depicted at 505, the helically shaped structure portion 104 can include one entire scroll ending in a hook like structure 501 that can be used to provide better engaging of a wire 202 that includes a cap or part attached thereto. In some embodiments, the hook like structure 501 can tie the cap or part to prevent the wire 202 from coming lose due to friction or movement, for example, while pulling the wire 202 in a desired direction.

In yet other embodiments, as depicted at 510, the helically shaped structure portion 104 can include less than an entire scroll ending in a tip structure 502 which may extend in a direction that is aligned to the direction of the handle 103. In some embodiments, the directional alignment can decrease friction caused when the wire handheld tool 110 is being inserted into and/or removed from the wire loom split tubing 201. In addition, the tip structure 502 may assist guiding the wire 202 being inserted into the wire loom split tubing 201 according to the disclosure.

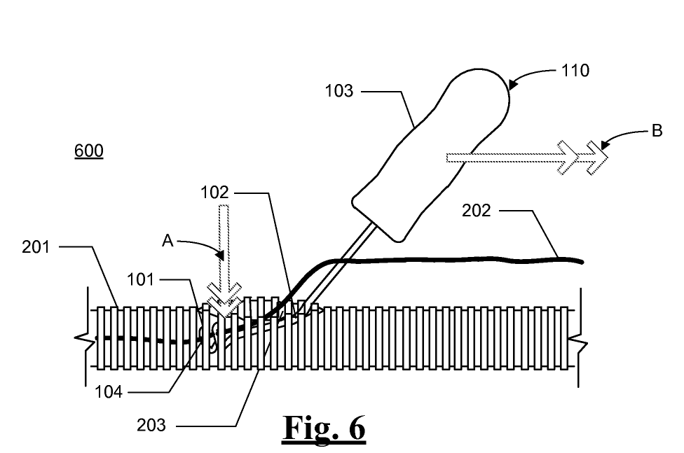

Referring now to FIG. 6, a side view 600 of the exemplary wire handheld tool 110 of FIG. 1 inserting and guiding a wire 202 into wire loom split tubing 201 is depicted. According to some aspects of the disclosure, the wire handheld tool 110 can be used as a means to insert and/or guide one or more wires 202 into wire loom split tubing 201. The wire 202 may be inserted and guided, for example, by inserting a portion of the wire 202 into the helically shaped structure portion 104 of the shank's 102 wire engaging end 101, inserting the wire engaging end 101 with the engaged wire 202 portion into the groove opening 203 of the wire loom split tubing 201, and guiding the wire 202 into the wire loom split tubing 201 by moving the wire handheld tool 110 using the handle 103 along a length, shown by arrow B, of the wire loom split tubing 201 thereby pushing, shown by arrow A, and ultimately guiding the wire 202 into a space inside the wire loom split tubing 201. In this regard, the wire 202 may not move in the direction of arrow B, only moving in the direction of arrow A into the wire loom split tubing 201.

As stated previously, in some embodiments the wire 202 may be engaged through means that do not require inserting the wire 202 into the helically shaped structure portion 104, including but not limited to, coupling the wire holding feature 401 of the wire engaging end 101 with a section of the wire 202 and/or a wire component.

It is to be understood that any feature described in relation to any one aspect may be used alone, or in combination with other features described, and may also be used in combination with one or more features of any other of the disclosed aspects, or any combination of any other of the disclosed aspects.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A wire handheld tool for at least one of inserting, removing and replacing a wire into a wire containing split duct, the wire handheld tool comprising:
a handle configured to be held by a user;
a longitudinal shank with a first end connected to the handle; and
the longitudinal shank including a second end comprising a wire engaging portion, wherein the wire engaging portion is configured to guide one or more wires into or out of the wire containing split duct.

2. The wire handheld tool of claim 1, wherein the wire engaging portion includes a helically shaped structure.

3. The wire handheld tool of claim 2, wherein the helically shaped structure comprises a curved spiral geometry.

4. The wire handheld tool of claim 3, wherein the curved spiral geometry comprises one or more spiral scrolls.

5. The wire handheld tool of claim 3, wherein the curved spiral geometry is configured to engage one or more wires by a rotating motion of one of the handle and the wire.

6. The wire handheld tool of claim 1, wherein the longitudinal shank comprises a wire coupling feature that is configured to move the wire into and out of the wire containing duct and allow the wire to slide there through.

7. The wire handheld tool of claim 1, wherein the handle comprises an ergonomically designed substantially cylindrical shape.

8. The wire handheld tool of claim 1, wherein the handle comprises an ergonomically designed T-Shape.

9. The wire handheld tool of claim 1, wherein the handle comprises a rigid non-conductive composition.

10. The wire handheld tool of claim 1, wherein the handle comprises a non-conductive coating.

11. The wire handheld tool of claim 1, wherein the wire engaging portion comprises an extending tip structure directionally aligned to the handle.

12. The wire handheld tool claim 1, further comprising a wire supporting structure protruding from the longitudinal shank and proximate to an end of said wire engaging portion.

13. The wire handheld tool of claim 1, wherein the longitudinal shank is configured with at least one bend or configured to be bent to conform to a restricted working space.

14. A wire handheld tool for at least one of inserting, removing and replacing wiring into a wire containing split duct, the wire handheld tool comprising:
a handle configured to be held by a user;
a longitudinal shank with a first end contiguous to the handle; and
the longitudinal shank including a second end comprising a helically shaped wire engaging portion, wherein the helically shaped wire engaging portion of said second end of the longitudinal shank is configured to engage one or more wires associated with the wire containing split duct.

15. The wire handheld tool of claim 14, wherein the helically shaped wire engaging portion is configured to engage one or more wires by a rotating motion of one of the handle or wire.

16. The wire handheld tool of claim 15, wherein the helically shaped wire engaging portion comprises a curved spiral structure with one or more spiral scrolls.

17. The wire handheld tool of claim 14, wherein the helically shaped wire engaging portion is configured to disengage one or more wires by a rotating motion of one of the handle or wire.

18. The wire handheld tool of claim 14, wherein the handle comprises an ergonomically designed T-Shape.

19. The wire handheld tool of claim 14, wherein the handle comprises at least one of the following: a rigid non-conductive composition, a non-conductive coating, and a sponge like top layer.

20. The wire handheld tool of claim 14, additionally comprising a wire supporting structure protruding from the longitudinal shank and proximate to the helically shaped wire engaging portion.
